(19) United States
(12) Patent Application Publication
(10) Pub. No.: US 2009/0323353 A1
(43) Pub. Date: Dec. 31, 2009

(54) Light Collar

(75) Inventors: Peter E. Rising, Brightwaters, NY (US); John Remmer, Oakdale, NY (US)

Correspondence Address: F. CHAU & ASSOCIATES, LLC, 130 WOODBURY ROAD, WOODBURY, NY, 11797, US

(73) Assignee: INDUSTRIAL MUNICIPAL EQUIPMENT, INC., Eldersburg, MD (US)

(21) Appl. No.: 12/278,234

(22) PCT Filed: Feb. 5, 2007
(86) PCT No.: PCT/US07/03046

§ 371 Date: Aug. 4, 2008

Related U.S. Application Data
(60) Provisional application No. 60/765,308, filed on Feb. 3, 2006.

(51) Int. Cl. F21V 3/00; F21S 8/10

(52) U.S. Cl. 362/311.03; 362/317

(57) ABSTRACT

A light collar includes an outside diameter, a first inside diameter, a second inside diameter greater than the first inside diameter forming a bore for receiving an ampoule well, and at least one port in an outer surface of the collar having a depth for receiving a light source.

### CROSS-REFERENCE TO RELATED APPLICATIONS

This application claims priority to International Application PCT/US2007/003046, filed on Feb. 5, 2007 in the U.S. Receiving Office, which claims the benefit of U.S. Provisional Application Ser. No. 60/765,308, filed on Feb. 3, 2006, which are herein incorporated by reference in their entirety.

### BACKGROUND OF THE INVENTION

1. Technical Field

The present invention relates to a system for analyzing the contents of an ampoule, and more particularly to a collar for directing light into the ampoule.

2. Discussion of Related Art

For certain applications, such as high volume testing (500-3000 tests per day) bacteria in urine analysis, a sample vessel containing urine (IME.TEST™ ampoule) needs to be inserted multiple times (a start reading and a finish reading) so that the entire batch of sample urines may be incubated simultaneously for a fixed period of time. This batch processing causes sample containers to be inserted once for an initial start of test reading and a second time for an end of test reading. If sample container is not inserted into the instrument performing the light transmission reading in the exact same rotational registration as the first measurement, a resulting reading can vary by as much as 50% (+/−). This rotational variation can render the comparison between the first and second readings meaningless. The variation in reading is caused by the variation of the sample container, particularly if said container has a conical shape at the top associated with an ampoule sealing technique (IME.TEST™ ampoule). Additionally, the large testing volume associated with each batch substantially prevents the test operator from taking the time that may be needed for the sample insertion process and manual alignment to a fixed registration mark.

Therefore, a need exists for a light collar for controlling the dispersion of light into an ampoule within a light transmission analysis device.

### SUMMARY OF THE INVENTION

According to an embodiment of the present disclosure, a light collar includes an outside diameter, a first inside diameter, a second inside diameter greater than the first inside diameter forming a bore for receiving an ampoule well, and at least one port in an outer surface of the collar having a depth for receiving a light source.

### BRIEF DESCRIPTION OF THE DRAWINGS

Preferred embodiments of the present invention will be described below in more detail, with reference to the accompanying drawings:

FIG. 1 is a diagram of a light collar according to an embodiment of the present disclosure;

FIG. 2 is a diagram of a light collar fitted to an ampoule well according to an embodiment of the present disclosure; and

FIG. 3 is a diagram of a system according to an embodiment of the present disclosure.

### DETAILED DESCRIPTION OF PREFERRED EMBODIMENTS

According to an embodiment of the present disclosure, a device scatters light emission to substantially eliminate rotational bias effects of formed ampoules (IME.TEST™ ampoule). The scattered light is substantially even and at a specific stage height such that measurements may be taken at specific wave length light transmission percentages over multiple ampoule insertions as done by the IME.TEST™ Autoanalyzer.

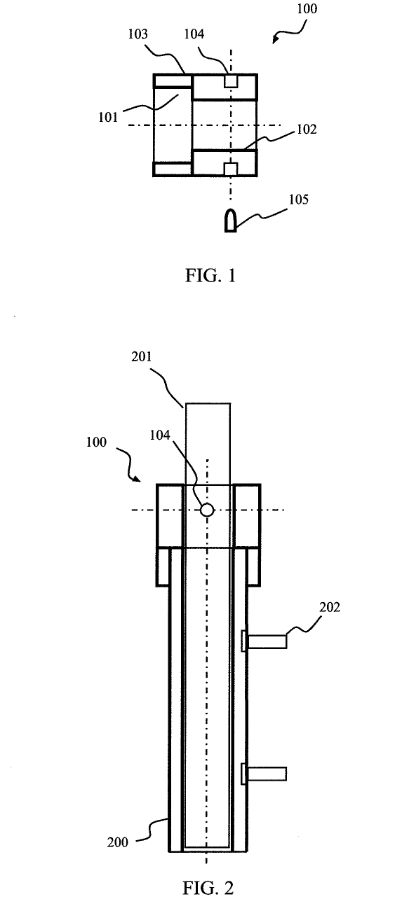

Referring to FIG. 1, according to an embodiment of the present disclosure, a method for forming a collar comprises cutting, transaxially, a translucent tube formed of, for example, Butyrate or Polybutyrate, into sections suitable for mounting in a light measuring device such as the IME.TEST™ Autoanalyzer. The resulting section 100, called a collar, is machined to form a bore 101 on an inner surface 102. An outer surface 103 of the collar 100 is partially ported with one or more holes 104 suitable for the insertion of a desired light source (e.g., an LED). A lens of a light is imbedded in the collar 100 at a depth sufficient to create a halo when the light is in an on state. The light is sealed in the hole 104. An interface between the collar and the lens of the light is wetted, for example, by a glue for sealing the light. The wetting substantially eliminates any effect of frosting of the surface of the hole caused by the porting.

An exemplary collar 100 may have an outside diameter of 0.750 in. and an inside diameter of 0.500 in. The holes 104 may be, for example, 0.100 in. deep and 0.125 in. wide. The collar 100 may be 0.750 in. high having a bore 101 0.300 in. deep. One skilled in the art would recognize that other dimensions may be used.

The holes 104 are positioned in a geometric location so that, depending on the number of lights intended for use in the collar, having a substantially equal arc of a circle between the partial light ports 104. For example, a collar 100 having two lights includes light ports located 180 degrees apart while a collar having three light ports would have their locus 120 degrees apart.

After creation of the partial ports 104, wide lens light sources 105 are imbedded into the collar 100, for example, as by a gluing operation. Commercially available glues may be used. The imbedded may alternatively include a friction fitting of the light sources or a mechanical lock fixing the lights to the collar. Once the imbedding has been completed the collar is mounted in the analyzing instrument at the specific stage height needed to perform light transmission into the sample container. More particularly, the collar 100 is mounted to an ampoule well 200 having a depth for receiving an ampoule 201 such that the collar is positioned at the desired stage height.

Light emitted by a light source coupled to the collar is diffused around through the collar forming a halo of light. Variations of light passing through the sample container due to rotation caused by the irregularities of the sample container, e.g., where a light source is disposed above the ampoule or to a side of the ampoule, are reduced from greater than about 50% to less than about 1% variation. The stage height of the light emitter or focus point of the light on the sample is precisely controlled, wherein the ampoule contacts a bottom of the well and the height of the collar from the bottom is substantially fixed. The distance between the collar including the light emitter and the sample in the amouple is reduced for the measurement application, e.g., the collar is disposed below a height of the sample in the ampoule. In addition, the opportunity for light source movement, damage or hindrance is low.

The ampoule well further includes studs 202 disposed on an outer sidewall for mounting the well to, for example, a circuit board. Additional light sources may be mounted to the outer sidewall of the ampoule well, for example, an infrared light source.

According to an embodiment of the present disclosure, a light collar may be implemented in conjunction with a liquid testing system includes a first well for receiving a sample to be tested, a first light source for illuminating the first well with light having a first wavelength, and a second light for illuminating the first well with light having a second wavelength. At least one of the first light source and the second light source are imbedded in the light collar. The liquid testing system further includes a light control, coupled to the first light source and the second light source, for selecting one of the first light source or the second light source to illuminate the first well, a light detector receiving light passing through the first well, and a processor, coupled to the light control and the light detector, for determining a light characteristic of the sample over time.

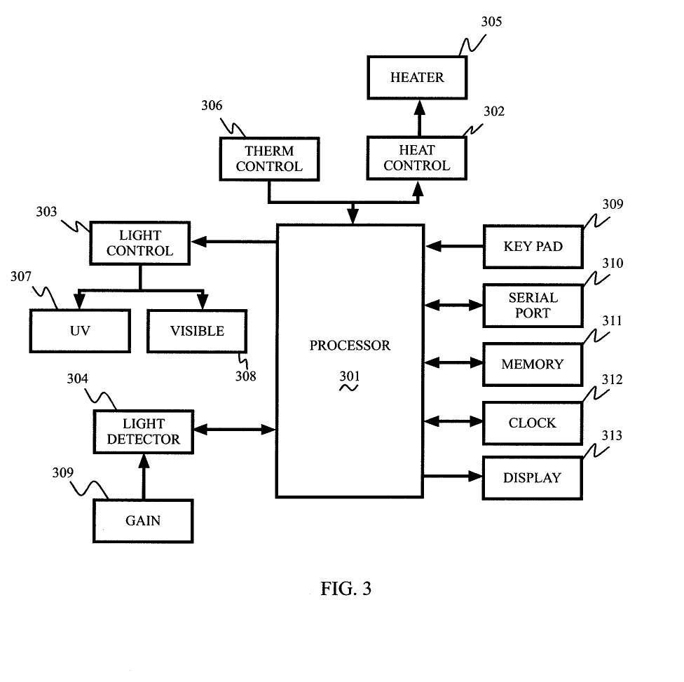

More particularly, referring to FIG. 3, a control circuit of the liquid testing system includes a processor 301 coupled to a heat control device 302, a light control device 303, and a light detection device 304. The heat control device 302 controls a heating element 305 for controlling an incubation temperature of an ampoule well and its contents. The processor 301 receives temperature information from a temperature sensor 306, which forms a control loop with the processor 301, heat control device 302 and heating element 305 for controlling the temperature of the ampoule well. The light control device 304 is coupled to a light source, such as an ultraviolet light 307 or a visible light 308. The light detection device 304 monitors light passing through the test ampoule and any contents therein. A gain control 309 can be adjusted to control a sensitivity of the light detection device 304. Light information is passed to the processor 301.

Individual wells of the system may be controlled using a well specific heat control 302 and light control 303. Multiple lights 307-308 may be provided for each well. Likewise, multiple heating elements 305 may be provided for each well. Thus, the same or different tests may be preformed in different wells simultaneously. For example, one or more temperature profiles can be run simultaneously. Further still, different light sources can be used for different ampoules. Thus, for example, a test for Escherichia coli can be performed in a first ampoule well and a test for fecal Coliform can be performed in a second ampoule well. Separate results may be provided for each test.

The processor 301 may be coupled to additional devices, including, for example, an input device 309, such as a keypad, a serial port 310, a memory device 311, a clock 312, and a display 313.

Having described embodiments for a light collar, it is noted that modifications and variations can be made by persons skilled in the art in light of the above teachings. It is therefore to be understood that changes may be made in the particular embodiments of the invention disclosed which are within the scope and spirit of the invention.

What is claimed is:

1. A light collar formed of a material for diffusing light and formed in a shape of a ring comprising:
an outer surface having an outside diameter;
an inner surface a first inside diameter and a second inside diameter greater than the first inside diameter forming a bore for receiving an ampoule well; and
at least one port in an outer surface of the collar having a depth for receiving a respective light source.

2. The light collar of claim 1, wherein the material is one of Butyrate and Polybutyrate.

3. The light collar of claim 1, coupled to an ampoule well.

4. The light collar of claim 1, wherein each light source is imbedded in the respective at least port at a depth sufficient to create a halo when each light source is in an on state.

5. The light collar of claim 1, wherein each light source is sealed in the port.

6. The light collar of claim 1, wherein an interface between the light collar and each light source is wetted.

7. The light collar of claim 1, wherein the at least one port is positioned in a geometric location, wherein depending on a number of light sources, have a substantially equal arc of a circle between the at least one port.

8. The light collar of claim 1, wherein the light source is friction fit in the at least one port.
